(19) United States
(12) Patent Application Publication
(10) Pub. No.: US 2015/0066551 A1
(43) Pub. Date: Mar. 5, 2015

(54) FLOW LINE DATA ANALYSIS DEVICE, SYSTEM, PROGRAM AND METHOD

(71) Applicant: NEC Corporation, Tokyo (JP)

(72) Inventor: Hiroo Harada, Tokyo (JP)

(21) Appl. No.: 14/389,399

(22) PCT Filed: Mar. 18, 2013
(86) PCT No.: PCT/JP2013/001834

§ 371 Date: Sep. 30, 2014

(30) Foreign Application Priority Data
Mar. 30, 2012 (JP) 2012-080278

(51) Int. Cl. G06Q 10/06

(52) U.S. Cl. CPC G06Q 10/063
USPC 705/7.11

(57) ABSTRACT

A flow line analysis device includes a log storage unit that stores work log including key information which encompasses at least one of worker information, slip information and work item, and work information associated with the key information, a flow line storage unit that stores flow line data of the worker, and a control unit, wherein the control unit extracts work information associated with a specific key information from the work log, and determines whether the flow line data which includes flow line work information which satisfies predetermined condition defined by work information, and associates the key information with the flow line data when it is determined that the flow line data includes the flow line work information.

### TECHNICAL FIELD

The present invention relates to a flow line data analysis technology for associating key information with flow line data.

### BACKGROUND ART

As a technology related to the present invention, in patent literature (PTL) 1, a technology for use in collecting trends of customers has been disclosed. In this technology, an association of customer flow line data, which has been recognized by a flow line recognition system installed in a particular region of a store, with customer trading data, which has been processed by a settlement apparatus, is made by utilizing person images of customers.

Concretely, a collection apparatus for collecting trends of customers selects the flow line data associated with a person who has been located within an image monitoring region from among the flow line data per person stored in a flow line database. Further, this collection apparatus selects sales floor image data at the time when the person corresponding to the selected flow line data has been located within the image monitoring region from a sales floor image database, and extracts a person image corresponding to the person from the selected sales floor image data.

Moreover, the collection apparatus collates an extracted person image with each of customer image data stored in a customer image database, and searches for customer image data which has been obtained in advance by photographing the person corresponding to the extracted person image. When the desired customer image data has been detected, the collection apparatus associates identification information corresponding to trading data associated with the detected customer image data with identification information corresponding to the selected flow line data, and stores the identification information corresponding to the trading data. Such a technology as described above has been disclosed in PTL 1.

### CITATION LIST

### Patent Literature

[PTL 1] Japanese Unexamined Patent Application Publication No. 2011-170565

### SUMMARY OF INVENTION

### Technical Problem

However, in such a technology disclosed in PTL 1, since person images resulting from photographing customers at a position near a point of sale system (POS) terminal are used, unless a person targeted for photographing passes by a particular place, such as a cash register, it is difficult to perform photographing for obtaining a person image sufficient for use in image recognition. Thus, it is difficult to associate customer flow line data with customer trading data. Further, in the case where collation is performed by using person images, it is necessary to make the accuracy of a photographed image higher, and thus, an installation place for a camera is restricted.

An exemplary object of the present invention to solve the aforementioned problem is to provide a device, a system, a program and a method for a flow line analysis which associates key information which includes the worker information or the slip information, with the flow line data related to a worker without performing any collation on a person image basis.

### Solution to Problem

A flow line analysis device according to the present invention, includes: a log storage unit which stores work log including key information which encompasses at least one of worker information, slip information and work item, and work information associated with the key information; a flow line storage unit which stores flow line data of the worker; and a control unit, wherein the control unit extracts work information associated with specific key information from the work log, and determines whether the flow line data which includes flow line work information which satisfies a predetermined condition defined by work information, and associates the key information with the flow line data when it is determined that the flow line data includes the flow line work information.

A flow line data analysis method according to the present invention, includes:

storing a work log including key information which encompasses at least one of worker information, slip information and a work item, and work information associated with key information;

storing flow line data associated with a worker;

extracting work information associated with specific key information from the work log;

determining whether the flow line data which includes flow line work information which satisfies a predetermined condition determined in accordance with the work information; and

associating the specific key information with the flow line data when it is determined that the flow line data includes the flow line work information.

A flow line analysis program which makes a computer operate as functions for analyzing flow line data, according to the present invention, includes:

a log storage unit which stores work log including key information which encompasses at least one of worker information, slip information and work item, and work information associated with the key information;

a flow line storage unit which stores flow line data of the worker; and

a control unit which extracts work information associated with specific key information from the work log, and determines whether the flow line data which includes flow line work information which satisfies a predetermined condition defined by work information, and associates the key information with the flow line data when it is determined that the flow line data includes the flow line work information.

### Advantageous Effects of Invention

The present invention makes it possible to provide a system, a program and a method for a flow line analysis which associates key information which is the worker information or the slip information, with the flow line data related to a worker without performing any collation on a person image basis.

### BRIEF DESCRIPTION OF DRAWINGS

FIG. 1 is a block diagram according to an exemplary embodiment 1 of the present invention.

FIG. 2 is a flowchart according to the exemplary embodiment 1 of the present invention.

FIG. 3 is a block diagram according to an exemplary embodiment 2 of the present invention.

FIG. 4 is an example of flow line data according to the exemplary embodiment 2 of the present invention.

FIG. 5A is an example of flow line data according to the exemplary embodiment 2 of the present invention.

FIG. 5B is an example of flow line data according to the exemplary embodiment 2 of the present invention.

FIG. 6 is an example of flow line data according to the exemplary embodiment 2 of the present invention.

FIG. 7 is an example of flow line data according to the exemplary embodiment 2 of the present invention.

FIG. 8 is a flowchart according to the exemplary embodiment 2 of the present invention.

FIG. 9 is an example a flow line work task information list according to the exemplary embodiment 2 of the present invention.

FIG. 10 is a diagram of a system configuration according to an exemplary embodiment 3 of the present invention.

FIG. 11 is an example of flow line data according to the exemplary embodiment 3 of the present invention.

FIG. 12 is an example of work log according to the exemplary embodiment 3 of the present invention.

FIG. 13A is an example of shelf assignment information according to the exemplary embodiment 3 of the present invention.

FIG. 13B is an example of shelf assignment information according to the exemplary embodiment 3 of the present invention.

FIG. 14 is a flowchart according to the exemplary embodiment 3 of the present invention.

FIG. 15 is a diagram according to another exemplary embodiment of the present invention.

### DESCRIPTION OF EMBODIMENTS

Hereinafter, exemplary embodiments of the present invention will be described with reference to the drawings. It is to be noted here that the following exemplary embodiments will be described by way of an example of an association of worker flow line data of a worker with a specific worker in a warehouse or a factory, but the exemplary embodiments is not limited to this. The present invention can be also applied to the identification of worker using other means, such as a face collation at a specific passing location.

Here, the worker include the whole of persons skilled in any one of works such as an acquisition of articles, an arrangement of articles and processing of goods (bolting, drilling and cutting with tools, painting and the like). Besides human being, a riding machine such as a forklift, an automated robot, a trained animal and the like can be also included in the worker. Further, a work performed by the worker includes a work for an acquisition of articles, a work for an arrangement of articles, a work for processing of goods (such as a work using an installed tool of large size, an installation of a wheel and an installation of a door in the assembly of cars in a train-car assembling factory), and the like.

The present invention is unnecessarily to be limited to configurations and operations illustrated in drawings of exemplary embodiments described below and, appropriately, the configurations and the operations can be subjected to an addition of, and/or a change to, other configurations and other operations, respectively. Further, individual constituent components of exemplary embodiments described below may be included in a single device as a whole, or may be separately included in each of a plurality of devices which are functionally independent with one another.

### Exemplary Embodiment 1

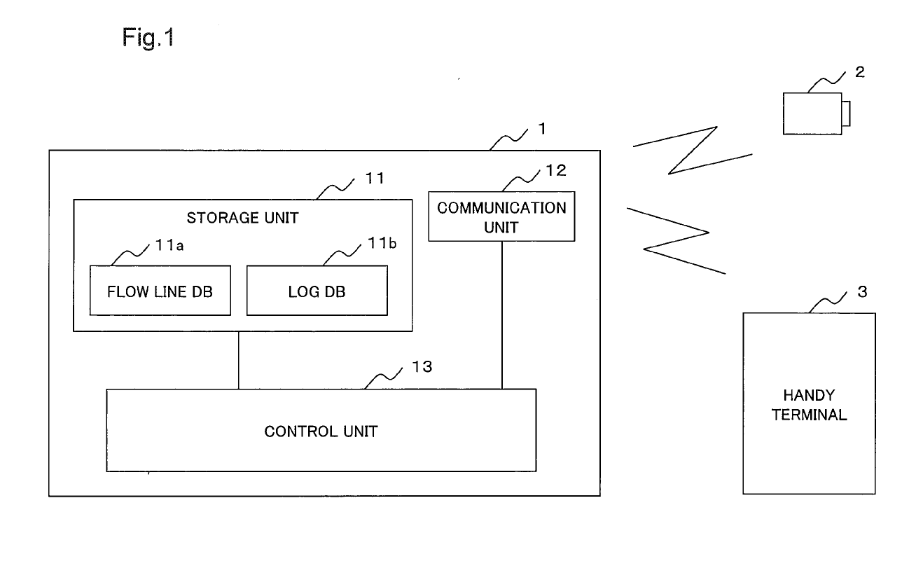

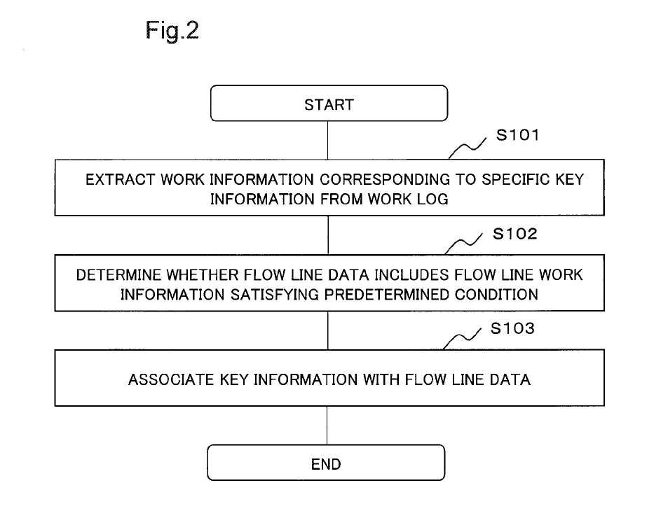

First, an exemplary embodiment 1 will be described with reference to FIGS. 1 and 2.

FIG. 1 is block diagram illustrating a flow line data analysis system of this exemplary embodiment 1. The flow line data analysis system of this exemplary embodiment 1 includes a flow line data analysis device 1, a location detection device 2 and a handy terminal 3. Further, in exemplary embodiments and drawings described below, a case where the location detection device 2 is constituted by a camera will be described as an example of the location detection device 2, but any location detection device, such as a wireless terminal carried by the worker, which detects the location of the worker who moves inside a warehouse or a factory and outputs the location of the worker to the flow line data analysis device 1, is sufficient as the location detection device 2.

The flow line data analysis device 1 includes a storage unit 11, a communication unit 12 and a control unit 13.

The storage unit 11 includes a flow line database (DB) 11a (also referred to as a flow line storage unit) and a log database (DB) 11b (also referred to as a log storage unit). The flow line DB 11a stores flow line data generated by the control unit 13 from image data outputted from the location detection device 2. Here, the flow line data corresponds to a track of the worker who moves inside a warehouse or a factory, and may include place information and time information for representing a movement history. The place information in this case may be information which designates a location relative to an appropriately determined specific reference point by using coordinate information (referred to as warehouse coordinates) which is specified by using a distance of an east-west direction element, a distance of a south-north direction element and a distance of a vertical direction element each from the reference point. In this case, for example, the flow line data is handled information recording in the form of an array in which are associated warehouse coordinates of the worker and clock time.

Further, a region targeted for photographing inside the warehouse or the factory is segmented so as to form a grid pattern, such as a square pattern on a Go board, which is obtained by vertically and horizontally arranging line segments at even intervals, and in order to uniquely specify each of the grids, a set of rows and a set of columns resulting from the segmentation are denoted, for each of the sets, by numbers or signs, such as [I, II, III, IV, . . . ] or [a, b, c, d, . . . ]. A list resulting from recording, for each of the grids (also referred to as cells), an entry clock time, an exit clock time and the like, together with sign for specifying the location of the each of the grids (this sign being referred to as a grid number or a cell number) may be handled as the flow line data.

Moreover, the flow line data may be a list which is generated by utilizing an image analysis technology, and which includes actions, such as an acquisition of articles, an arrangement of articles and processing of goods, each supposed to have been performed by a worker, as well as pieces of time information each being associated with the actions, and presenting time information at which a worker has taken the corresponding action. The action, which is supposed to have been performed by a worker, means an action, such as stopping, squatting, passing by a place where articles are arranged, stretching arm, picking up an article, placing an article on a shelf, bolting, drilling and cutting using tools, installing a component, or painting. In this description, hereinafter, the action suggesting that the worker has performed will be also referred to as flow line work action information.

Further, the flow line data may be the flow line data resulting from generating from data outputted from a single location detection device 2, or may be the flow line data resulting from rebuilding data outputted from a plurality of location detection devices 2 such that the flow line data is associated with data related to an identical worker and is composed of flow line data including passing positions or passing clock times which are arranged continuously in time series. The log DB 11b stores a work log which has been transmitted from the handy terminal 3 via the communication unit 12.

Here, the work log includes data representing some kinds of information related to the article which has been acquired or arranged by a relevant worker as well as data representing a work item (bolting, an installation of components, or the like), and forms a list containing key information as well as work information associated with key information. A set of the key information includes at least one of the worker information related to worker (a name, a code and/or the like), slip information (a slip number and/or the like) and a work item (bolting, an installation of component, and the like). Further, a set of the work information includes information related to a work item corresponding to a work performed by the worker (hereinafter, these kinds of information being collectively also referred to as work-item work information), as well as the article work information. Here, the work-item work information includes, for example, groups of: clock times (hereinafter, also referred to as log clock time information) at which a relevant worker has carried out a work corresponding to a relevant work item; places at which a relevant worker has carried out a work corresponding to a relevant work item; tool information related to tools for use in a work; and the like. Further, the article work information includes article information (article numbers, article names, and/or the like, each related to the article having been acquired by a relevant worker); total numbers, as well as total numbers of article types, each related to articles having been used in a work a relevant worker has performed; clock times at which the relevant worker has worked on an article (hereinafter, which will be unified into the log clock time information); and the like.

The storage unit 11 may be constituted by a read only memory (ROM), a magnetic storage memory device, such as a flash memory, or a non-volatile memory, such as a hard disk, or may be constituted by a volatile memory, such as a random access memory (RAM). Further, each of the flow line DB 11a and the log DB 11b may be stored in storage media which are physically different from each other, or both of the flow line DB 11a and the log DB 11b may be stored in the same storage medium.

The communication unit 12 communicates with the location detection device 2 and the handy terminal 3 via wireless communication. Besides, the communication unit 12 may communicate with them via short distance wireless communication, such as Bluetooth (registered trademark) or infrared communication, or wired communication via cables or the like. Further, the communication unit 12 is capable of communicating with servers or the like by connecting with a network, such as the Internet or an intranet.

The control unit 13 detects a worker who is moving within a flow line recognition region and generates the flow line data related to this worker by applying an image processing technology to of the image data from the location detection device 2. Herein, the control unit 13 stores the generated flow line data into the storage unit 11. Here, the control unit 13 may be configured to generate flow line data by using the image data each from a plurality of location detection devices; generate an flow line data related to an identical person by interlinking flow line data related to the identical person among the plurality of flow line data; and store the flow line data related to an identical person into the storage unit 11. The control unit 13 is capable of, from a relevant the flow line data, detecting flow line work action information suggesting action that is supposed to have been worked on the article by the worker. Further, the control unit 13 is also capable of, from a relevant the flow line data, extracting flow line work information which is associated with the flow line work action information, and which corresponds to time information, place information and the like which are related to a work having been performed by the worker, such as an acquisition of articles, an arrangement of articles, or processing of goods.

Moreover, the control unit 13 extracts work information (such as, the article work information) corresponding to the specific key information, from a work log. Further, the control unit 13 determines whether flow line data includes flow line work information each of which satisfies any one of predetermined conditions each determined in accordance with the extracted at least work information. For example, work time standards each associated with work item may be stored in the storage unit 11 in advance, and the control unit 13 may determine whether, for flow line data, the extracted work-item work information satisfies predetermined condition determined in accordance with the work time standards. Further, in the case where it is determined that a specific flow line data includes flow line work information which satisfies the predetermined condition, the control unit 13 associates the specific key information included in the work log with the specific flow line data.

Here, the control unit 13 may be constituted by a central processing unit (CPU) or the like. Further, the control unit 13 may be physically configured to cause individual operations to be executed by a single CPU or the like or cause each of the operations to be a plurality of CPUs or the like.

The location detection device 2 detects a location of the worker moving inside a warehouse or a factory, and outputs the location of the worker to the flow line data analysis device 1. For example, a camera may be employed as the location detection device 2. The camera itself may possess a processing mechanism for a tracing function for tracing a flow line of the worker, or a control unit or a different externally connected device, which has received image data signals from a camera functioning as a location detection device may possess a function equivalent to the tracing function. The number of cameras may be just one, or maybe two or more.

Further, with respect to a method for tracing a flow line of the worker, various technologies have been already devised and, as an example thereof, there exists a technology disclosed in Japanese Unexamined Patent Application Publication No. 2000-200357, but without being limited to this technology, an appropriate method for tracing a flow line may be used. Here, the camera may be a wide-angle lens camera, such as a camera using a fish-eye lens or a camera with a mirror of all directions. Further, the camera is capable of transmitting image data to the flow line data analysis device 1 via wireless communication or wired communication.

Further, the location detection device 2 may perform location detection by using wireless signals from a mobile terminal carried by the worker. Further, the location detection device 2 may be configured so as to be capable of performing location detection by using ultrasonic waves, and may be configured to perform location detection while receiving ultrasonic waves from an ultrasonic generation device carried by the worker, or may be configured to perform location detection while detecting reflected waves which arise when the worker has passed by one of ultrasonic generation devices which are installed at some places inside a warehouse or the like. Besides, the location detection device 2 may be configured to use a different appropriate means which can be used for specifying the location of the worker. For example, the detection of the location of the worker may be performed by using, for example, a global positioning system (GPS) terminal; a terminal in which an acceleration sensor and an gyro sensor is combined; or RFID readers as well as RFID tags each for use in location detection and carried by the worker.

Here, the location detection device 2 may be configured to perform not only detection but also a generation of a worker flow line data including data related to traces of the worker, and transmit the worker flow line data to the flow line data analysis device 1. In this case, as a result, the location detection device is provided with a flow line data generation portion.

The handy terminal 3, which is a terminal carried by the worker, acquires work log having been described in the above description of the log DB 11b in the above-mentioned storage unit 11, and transmits the acquired work log to the flow line data analysis device 1. The article information can be detected by attaching a wireless tag, such as an RFID tag, onto an article, and utilizing a wireless communication technology, such as a radio frequency identification (RFID) technology. Further, the article information may be detected by attaching a barcode onto an article, and using a barcode reader. In addition, in this exemplary embodiment, any device capable of detecting that a specific worker has worked on a specific article and transmitting log of the work to the flow line data analysis device 1 can be used in substitution for the handy terminal. Moreover, the handy terminal 3 may be a tablet terminal in which such a work check list application as is capable of verifying work item and recording work clock times is embedded.

Next, operations of this exemplary embodiment will be described with reference to FIGS. 1 and 2. In a flowchart shown in FIG. 2, there are described operations in which the control unit 13 associates the key information (the worker information or the slip information) included in a work log with the flow line data. These operations may be performed in such a program as is executed in a single computer.

The control unit 13 extracts work information corresponding to the specific key information from a work log stored in the log DB 11b (S101). As an example, the control unit 13 extracts a clock time (log clock time information) at which the worker has worked on the article, or the like, from the work log. Next, the control unit 13 determines whether flow line data stored in the flow line DB 11a includes flow line work information which satisfies a predetermined condition determined in accordance with the extracted piece of work information (S102). As an example, the control unit 13 extracts log clock time information corresponding to the specific key information, and determines whether flow line data includes time information which falls within a predetermined range from the log clock time information. In this case, the control unit 13 may determine whether flow line data includes flow line work information which satisfies any one of predetermined conditions each determined in accordance with a plurality of work information corresponding to specific identical key information. Further, in the case where it is determined that a specific flow line data includes flow line work information which satisfies the predetermined condition, the control unit 13 associates the key information with the specific flow line data (S103).

According to this exemplary embodiment of the present invention, the above-described configuration makes it possible to, without performing any collation on a person image basis, associate key information, which is the worker information or the slip information, with a specific flow line data corresponding to the worker. Moreover, it is also possible to extract not only a single work information corresponding to the specific key information, but also a plurality of work information corresponding thereto, and determine whether flow line data includes a plurality of flow line work information each of which falls within any one of predetermined ranges each determined from the plurality of work information. In this way, it is possible to make the degree of accuracy of the association of key information with a flow line data higher than that in the case where only single work information is used. Moreover, since an association of an work log with an flow line data is made, the position of a location detection device is sufficient provided that the location detection device is placed at a position where the flow line data can be acquired, so that it is possible to apply some aspects of the invention even when a place, such as a warehouse or a factory, in which target worker do not always pass by a specific place, is a target for analyzing flow lines.

Here, in substitution for the above-described operation in S102, the control unit 13 detects flow line work action information from flow line data or from the output of the location detection device 2 by utilizing an image analysis technology. Further, the control unit 13 may be configured to, through the use of a list in which flow line work information (time information or place information) are each associated with the detected flow line work action information, determine whether flow line data includes flow line work information which is included in the listed flow line work information and which satisfies a predetermined condition determined in accordance with the extracted article work information from. The flow line work action information is information related to an action which suggests a work which is supposed to have been performed by the relevant worker. The action suggesting a work which is supposed to have been performed by the relevant worker means an action, such as stopping, squatting, passing by a place where articles are arranged, stretching arm, picking up an article, placing an article on a shelf, bolting, drilling and cutting with tools, installing a component, or painting.

In any one of the following exemplary embodiments, any action capable of associating the flow line data with worker identification information can be built in a range as far as those involved can conceive.

### Exemplary Embodiment 2

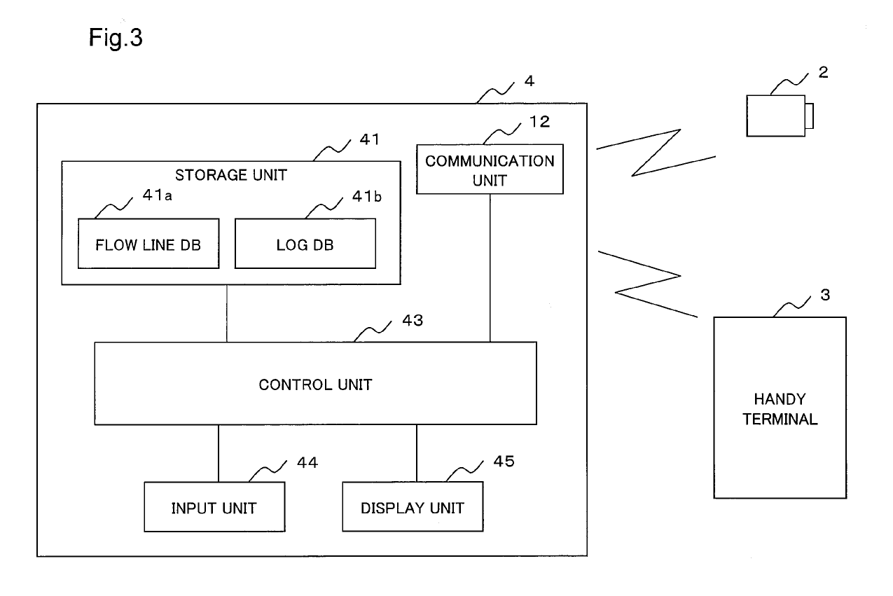

Next, an exemplary embodiment 2 will be described with reference to FIGS. 3 to 7. The same constituent elements as those of the exemplary embodiment 1 are each denoted by the same sign as that in the exemplary embodiment 1, and the description thereof will be omitted. In this exemplary embodiment 2, as the article work information in the exemplary embodiment 1, log clock time information at which a relevant worker has performed a work on the article is extracted. Further, in this exemplary embodiment 2, through the use of, as the flow line work information in the exemplary embodiment 1, time information related to movements of worker associated with flow line data, it is determined whether flow line data includes time information which is included in the time information and which falls within a predetermined range from the log clock time information included in an work log.

In FIG. 3, there is illustrated a flow line data analysis system of this exemplary embodiment 2. As one of configurations of such a flow line data analysis system, a flow line data analysis device 4 includes a storage unit 41, a control unit 43, an input unit 44 and a display unit 45.

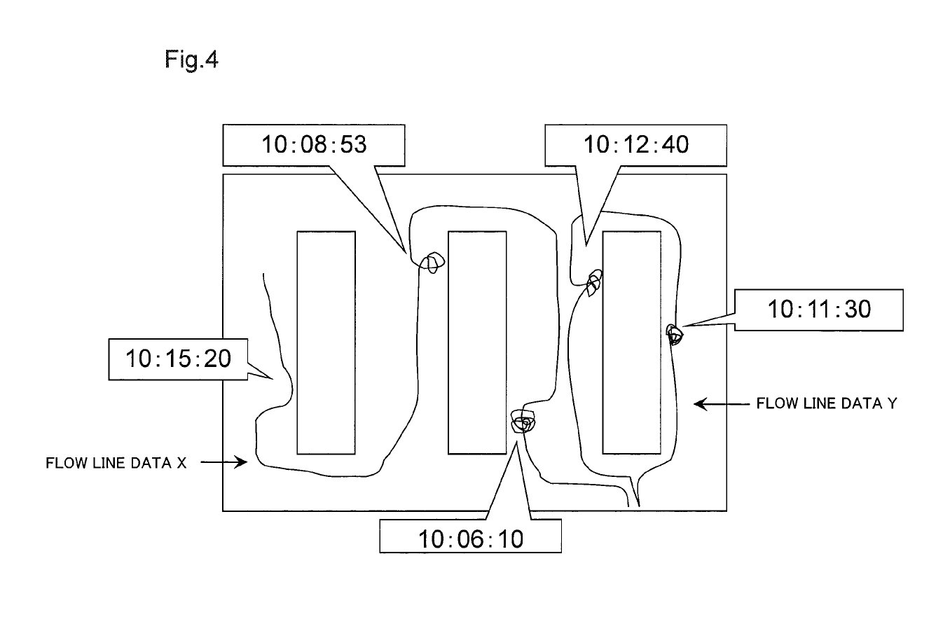

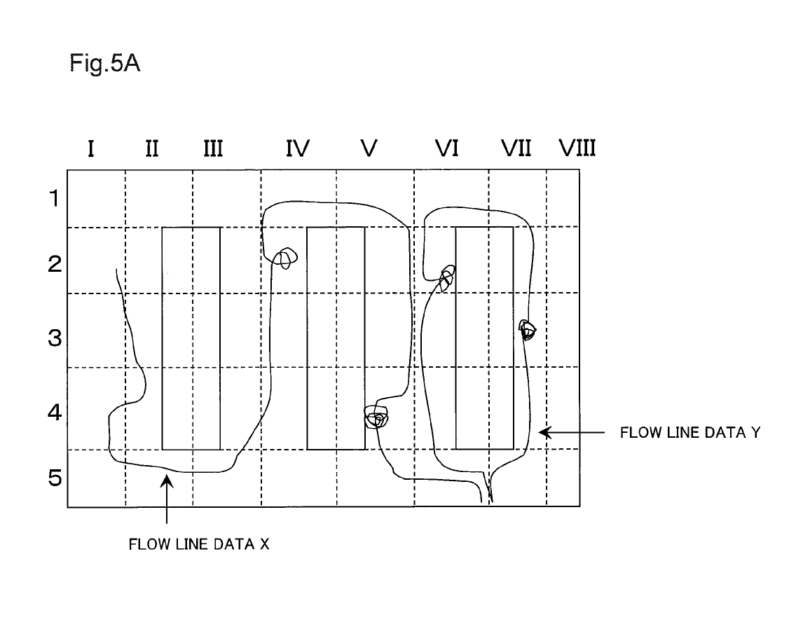

The storage unit 41 includes a flow line DB 41a and a log DB 41b. The flow line DB 41a stores flow line data which is generated by the control unit 43 from the image data from the location detection device 2. An example of the flow line data will be described with reference to FIGS. 4, 5A, 5B and 6. FIG. 4 is a diagram illustrating tracks of movements of worker in a warehouse or a factory. In FIG. 4, there are illustrated, besides the tracks, clock time information each associated with points on the tracks. This clock time information may be continuously detected but, alternatively, may be intermittently detected at intervals of a constant period of time. In FIG. 5A, there is illustrated an example in which flow line data within a photographing place of a warehouse or a factory is segmented by using grids just like such squares on a Go board. In FIG. 5B, there is illustrated an example in which entry clock times and exit clock times of a worker to/from their respective corresponding cells are indicated so as to form a list. time information as flow line work information in FIG. 5B may be a clock time having a width from an entry clock time until an exit clock time, or may be also a single clock time within a period of time when a worker exists within one of cells (for example, a clock time when a worker has come near the center of a relevant cell or a clock time when a worker has come near a relevant shelf). Further, place information in FIG. 5A may not be information resulting from segmenting a photographing place by using grids just like such squares on a Go board, but may be replaced by one of identification numbers for identifying paths.

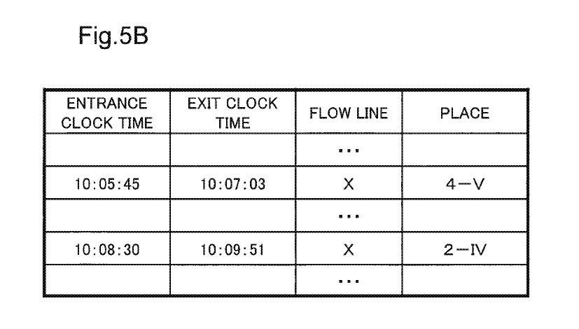

As shown in FIG. 6, flow line work action information (for example, stretching of an arm, picking up of an article, and the like), which are extracted beforehand from the image data outputted from the location detection device 2 by utilizing an image recognition technology, may be stored in a storage unit so as to form a list, together with time information each associated with the flow line work action information. Through the use of a list of such preliminarily extracted flow line work action information, when associating key information with flow line data, as compared with a case where each of the flow line work action information is extracted in series, it is possible to achieve the reduction of processing wait time, the reduction of concentration of processing loads and the improvement of a processing speed.

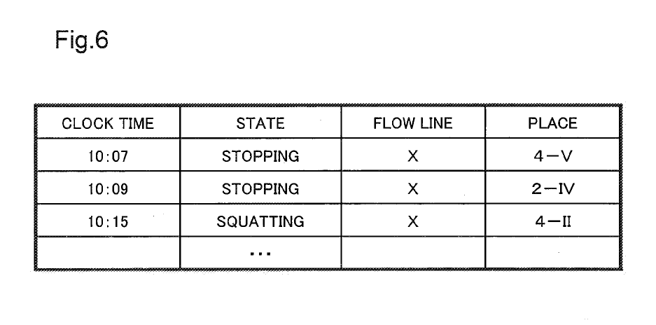

The log DB 41b stores a work log which has been transmitted from the handy terminal 3 and has been received via the communication unit 12, and retains a plurality of the work log as an work log. In FIG. 7, there is illustrated an example of the work log. Here, the work log includes data representing some kinds of information related to types of article on each of which a relevant worker has worked, and forms a list containing key information as well as article work information. In FIG. 7, the list includes, as the key information, the worker information related to a worker (a name, a code or the like) and slip information (a slip number or the like). Further, the list includes, as the article work information, log clock time information at which a worker has worked on the article as well as a total number of articles regarding the type of article. In addition, without being limited to these, other kinds of information, such as a manufacturer of the article, may be managed in this list. In addition, here, the log clock time information may not be necessarily an accurate clock time when a worker has picked up an article, but may be, for example, a clock time when a worker has checked an article with a handy terminal. As described above, even when there is a small difference between a clock time when a worker has worked on the article and a clock time when the worker has checked an article included in the type of article, there is no problem because, in this exemplary embodiment, it is confirmed whether flow line data includes time information which falls within a predetermined range from log clock time information.

The control unit 43 is capable of detecting flow line work action information from flow line data or the image data from a location detection device. The flow line work action information indicates an action taken by a worker who performs a work on an article, such as a stopping action, an arm stretching action, a squatting action or an action taken by a worker who has come near a shelf. Here, it can be detected whether a worker has passed by a shelf by determining, for example, whether the location of a worker existing on a path is within an area distanced from a shelf by a distance smaller than or equal to one second of the width of the path (which can be appropriately changed to a different distance, such as a distance smaller than or equal to one third of the width of the path), or whether a track corresponding to a target flow line data related to a worker is contacted with a shelf. In this exemplary embodiment, as an example, a stopping action is extracted as flow line work action information. A stopping action detection method performed by the control unit 43 can be realized by, through the use of flow line data, identifying a position corresponding to a fixed place at which a worker has stayed for a long time, or a position which corresponds to a place close to a shelf and on which traces of a movement of a worker are concentrated.

Further, upon detection of flow line work action information, the control unit 43 can extract time information corresponding to the flow line work action information. Here, the time information corresponding to the flow line work action information indicates a clock time having a width from a clock time when an action, which is associated with the flow line work action information and which suggests that a worker has performed a work on the article, has begun until a clock time when the action associated with the flow line work action information has ended. Alternatively, the time information corresponding to the flow line work action information may be a specific clock time, such as a middle clock time, between a clock time when an action, which is associated with the flow line work action information and which suggests that a worker has performed a work on the article, has begun and a clock time when the action associated with the flow line work action information has ended. Further, the control unit 43 extracts log clock time information corresponding to the specific key information, and determines whether flow line data includes time information which is included in the extracted time information and which falls within a predetermined range from the extracted log clock time information. Further, in the case where it is determined that a specific flow line data includes time information which satisfies the predetermined condition, the control unit 43 can associate the above specific key information with the specific flow line data.

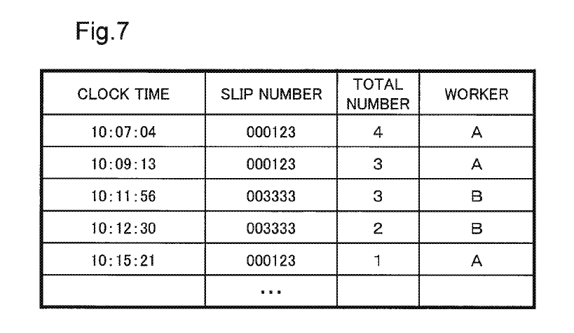

Next, operations performed by the control unit 43 will be described with reference to FIGS. 3 to 8. FIG. 8 illustrates a flowchart of operations performed by the control unit 43. In addition, these operations may be performed in such a program as is executed in a single computer.

The control unit 43 extracts log clock time information corresponding to the specific key information (for example, an identical worker, an identical slip number) from an work log stored in the log DB 41b (S201). As an example, referring to FIG. 7, log clock time information “10: 07: 04”, “10: 09: 13” and “10: 15: 21” corresponding to a worker A or a slip number “000123”, which is the specific key information, are extracted. In addition, the number of log clock time information to be extracted may be one.

Next, the control unit 43 detects flow line work action information from flow line data stored in the flow line DB 11a (S202). As an example of flow line work action information, a stopping action can be detected. A detection method for detecting such a stopping action can be realized by, for example, detecting a state where a track of a movement of a worker is not moving from a fixed area during a predetermined period of time, from flow line data shown in FIG. 4. Alternatively, the detection method for detecting the stopping action, can be realized by detecting a state where a trajectory of movements of a worker is staying at a specific area (a path or the like) during a period having a length longer than or equal to a predetermined period of time, from flow line data shown in FIG. 5A. Further, since the image data from the location detection device 2 are analyzed in advance, and a list of flow line work action information and time information is generated, it is possible to, through a retrieval of flow line data shown in FIG. 6, detect one or more flow line work action information corresponding thereto.

Further, the control unit 43 extracts time information each associated with the flow line work action information (S203). As an example, referring to a FIG. 4, time information “10: 06: 10”, “10: 08: 53”, and “10: 15: 20” corresponding to flow line data X as well as time information “10: 11: 30” and “10: 12: 40” corresponding to flow line data Y can be extracted.

Next, the control unit 43 determines whether flow line data includes time information which falls within a predetermined range from the extracted log clock time information (S204). As an example, let us consider a case where it is determined whether any one of the extracted time information falls within a predetermined range each having a width of one minute in each of an upward direction and a downward direction from the aforementioned log clock time information “10: 07: 04”, “10: 09: 13” and “10: 15: 21” corresponding to the worker A (or the slipping number “000123”). It can be understood that each of the time information “10: 06: 10”, “10: 08: 53” and “10: 15: 20”, which are associated with the flow line data X, falls within one of ranges each having a width of one minute in each of an upward direction and a downward direction from the aforementioned three log clock time information. As a result, the control unit 43 can determine that the flow line data X includes time information each falling within a predetermined range from log clock time information corresponding to the worker A.

Here, the method for determining whether time information falls within a predetermined range from extracted log clock time information is equivalent searching for pairs of the log time information to be minimum among each of the clock time and selecting an association which causes an average value which becomes minimum. As described above, log clock time information may not necessarily coincide with time information extracted from flow line work action information, and time information, which is one of the time information extracted from the flow line work action information and which is close to one of the log clock time information, can be associated. Further, it is also possible to make an association after having narrowed flow line data targeted for the association by using an earliest clock time and a latest clock time included in each of log clock time information corresponding to the specific key information.

Further, the control unit 43 associates the specific key information (the worker information, the slip information or the like) with the flow line data related to a worker (S205). As an example, the flow line data X, which includes time information each having a close relation with the aforementioned three log clock time information corresponding to the worker A (or the slip number “000123”), can be associated with the worker A (or the slip number “000123”).

In this way, in an aspect of the present invention, it is possible to, without performing any collation on a person image basis, associate the specific key information (the worker information, the slip information or the like) with an flow line data related to a worker by using log clock time information included in an work log as well as time information each associated with flow line work action information extracted from flow line data. Further, it is possible to improve the degree of accuracy of an association of the specific key information with an flow line data related to a worker to a greater degree as compared with the case of the exemplary embodiment 1 by using log clock time information and time information each associated with flow line work action information. Moreover, it is possible to further improve the accuracy of an association of the specific key information with an flow line data related to a worker by extracting a plurality of log clock time information from an work log, and associating the extracted plurality of log clock time information with a plurality of time information each associated with a plurality of flow line work action information.

Here, a beginning of these operations may be a beginning of an operation of this exemplary embodiment, which is an administrator's designation of a worker or the flow line data as the worker desired association target, using the input unit 44 and the display unit 45.

Further, in substitution for the above-described operations of S202 to S204, without extracting the time information each associated with the flow line work action information related to the flow line data X, the control unit 43 may determine whether flow line data includes time information which falls within a predetermined range from log clock time information. Specifically, through a direct comparison of log clock time information with time information each of which indicates a worker's movement and which is included in flow line data, the control unit 43 may determine whether each of the time information falls within a predetermined range of one minute in each of an upward direction and a downward direction from the aforementioned three log clock time information (“10: 07: 04”, “10: 09: 13” and “10: 15: 21”) corresponding to the worker A. In this way, it is possible to eliminate flow line data each having a time zone completely different from a time zone of each of the log clock time information. Alternatively, through the above-described elimination processing as preliminary processing to be performed prior to the operations in S202 to S204, the consumption of computation processing resources of a system can be suppressed, so that an association of the specific key information with an flow line data can be made efficiently.

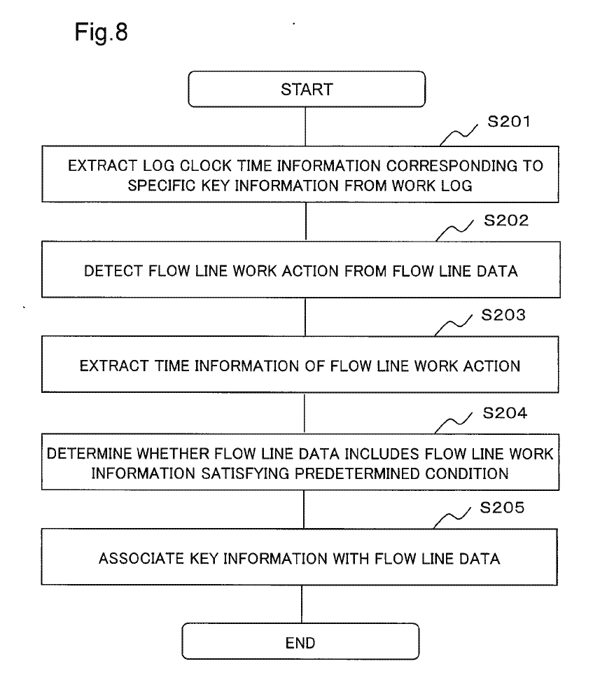

Moreover, through the above-described operations, as a result of an association of the specific key information with an flow line data corresponding to a worker, the control unit 43 can newly generate a list, shown in FIG. 9, in which the worker information related to worker is added.

### Exemplary Embodiment 3

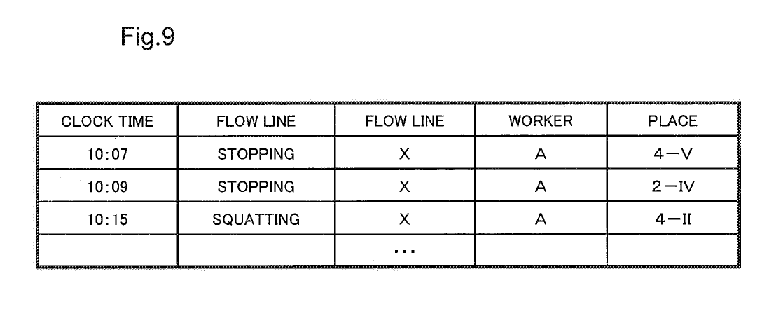

Next, an exemplary embodiment 3 will be described with reference to FIGS. 10 to 14. The same constituent components as those in the exemplary embodiments 1 and 2 are each denoted by the same sign, and the description thereof will be omitted. In this exemplary embodiment 3, an article information (for example, an article number, an article name and the like related to the article having been acquired or arranged by a worker) is treated as article work information. Further, in this exemplary embodiment 3, the article arrangement information, by which the article information is associated with arrangement information (for example, warehouse coordinates, a shelf number, a grid number, a cell number or the like) corresponding to the article, are provided. Further, a control unit extracts the article information corresponding to specific key information (the worker information, the slip information, or the like) from an work log, and extracts an arrangement place associated with the extracted article information by using the article arrangement information. Next, the control unit determines whether flow line data includes place information which falls within a predetermined range from the extracted arrangement place. Further, in the case where it is determined that flow line data includes place information falling within a predetermined range from the arrangement place, the control unit associates the flow line data with the key information included in an work log.

In FIG. 10, there is illustrated a flow line data analysis system of this exemplary embodiment 3. As an example of such a flow line data analysis system, a flow line data analysis device 5 includes a storage unit 51 and a control unit 53.

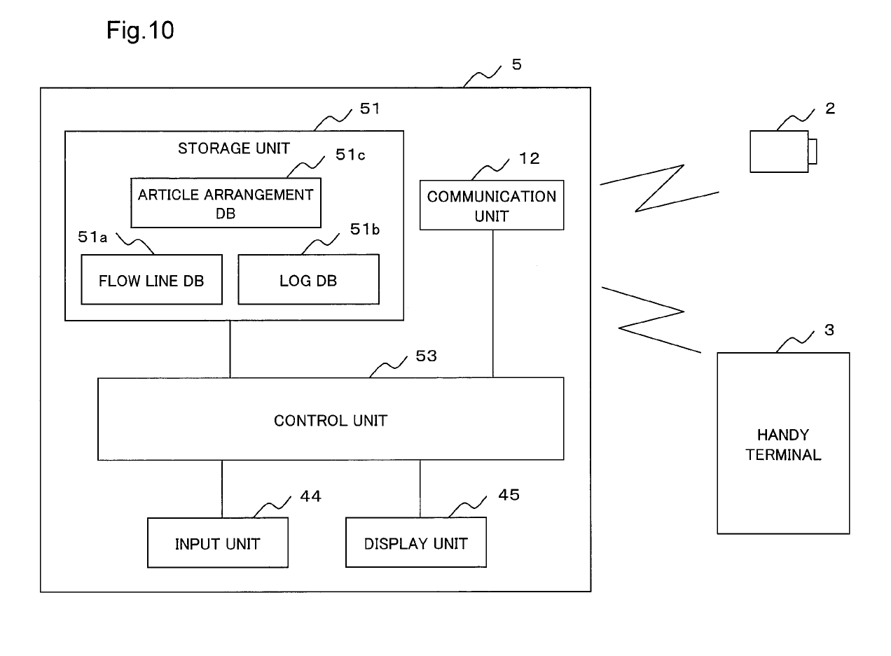

The storage unit 51 includes a flow line DB 51a, a log DB 51b and an article arrangement DB 51c. The flow line DB 51a stores flow line data generated by the control unit 43 from of image data from the location detection device 2. An example of the flow line data will be described with reference to FIG. 11. FIG. 11 is a diagram illustrating tracks of movements of worker in a warehouse or a factory as well as shelf numbers.

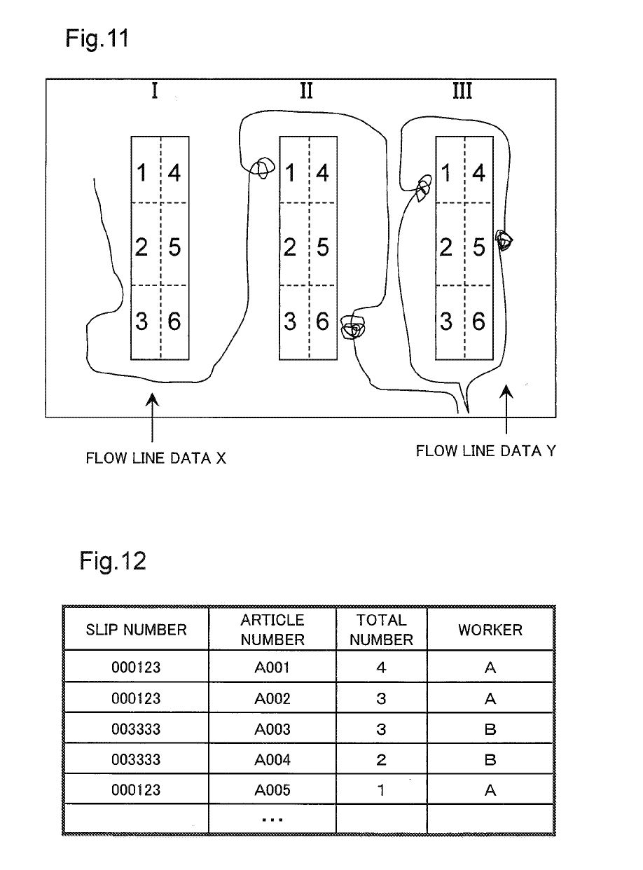

The log DB 51b stores a work log which has been transmitted from the handy terminal 3 and has been received via the communication unit 12, and retains a plurality of the work log as an work log. In FIG. 12, there is illustrated an example of the work log. Here, the work log includes data representing some kinds of information related to types of article on each of which a relevant worker has worked, and forms a list containing key information as well as the article work information. In FIG. 12, the list includes, as the key information, the worker information related to a worker (a name, a code or the like) and the slip information (a slip number or the like). Further, the list includes, as the article work information, the article information (the article number of the article on which a work, such as an acquisition or an arrangement, has been performed, and a total number of articles regarding the type of article). In addition, without being limited to these, other kinds of information, such as a manufacturer of the article, may be managed in this list.

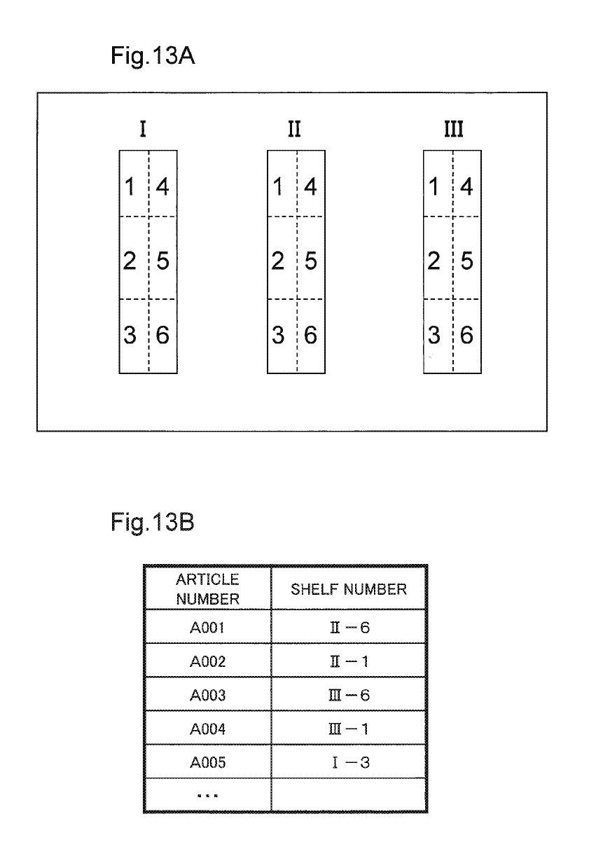

The arrangement DB 51c stores article arrangement information by which the article information (the article number, an article name or the like) is associated with arrangement information related to the article. Here, this arrangement information is, for example, coordinates on a warehouse, which indicates a location where a corresponding type of article is arranged. Further, as another example of the arrangement information, as shown in FIG. 13A and FIG. 13B, a shelf number at which the article is arranged may be stored together with the article information so as to form a list. In this case, the article information can be associated with arrangement information related to the article by storing a different list in which a shelf number is associated with the corresponding coordinates on a warehouse. Moreover, as shown in FIG. 5A, the arrangement information related to the article may be a grid number (or a cell number) corresponding to a segment of a constant shape, which results from segmentation of a region inside a warehouse or a factory. Further, in substitution for the article information corresponding to the article arrangement information, any kind of information capable of identifying the article may be associated with a shelf number. Further, an object where articles are arranged may not be a shelf. As shown in FIG. 5 in the exemplary embodiment 2, the article arrangement DB 51c can also store, as article arrangement information constituting article arrangement information, the article and a grid number (or a cell number), which results from performing segmentation of a relevant region of a warehouse or a factory into segments each having a constant shape, by associating the grid number, as a certain kind of information capable of identifying the article, with the type of article.

The control unit 53 extracts the article information (such as, the article numbers) from the work log, and can extract arrangement information (pairs of warehouse coordinates, shelf numbers or the like) each associated with the article information, from the article arrangement information. Next, the control unit 53 can determine whether flow line data includes place information (warehouse coordinates, a shelf number, a grid number, a cell number or the like) which falls within a predetermined range from an arrangement place corresponding to the arrangement information. Further, the control unit 53 can detect work action information from flow line data or image data from a location detection device. This work action information indicates, just like in the case of the exemplary embodiment 2, an action taken by a worker who performs a work for an acquisition of an article, an arrangement of an article, or the like, such as a stopping action, an arm stretching action, a squatting action or an action taken by the worker who has come near a shelf. Further, the control unit 53 can extract place information each of which is related to flow line data and is associated with the flow line work action information. Moreover, the control unit 53 determines whether place information having been extracted from flow line data falls within a predetermined range from the arrangement place extracted from the article arrangement information. In the case where one of the flow line data includes place information which falls within the predetermined range, the control unit 53 can associate the specific key information (such as the worker information or the slip information) with the flow line data corresponding to a worker.

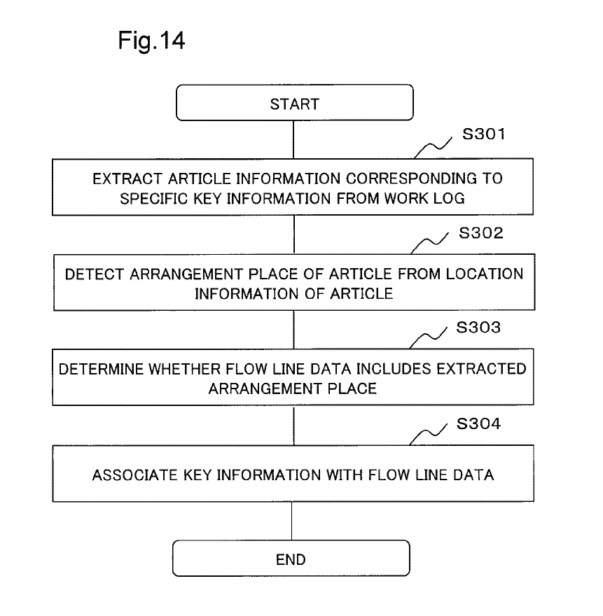

Next, operations performed by the control unit 53 will be described with reference to FIGS. 10 to 14. FIG. 14 is a flowchart illustrating operations of the control unit 53. In addition, these operations may be performed in such a program as is executed in a single computer.

The control unit 53 extracts article information (such as, article numbers) corresponding to a specific key information (such as an identical worker or an identical slip number) from the work log stored in the log DB 51b (S301). As an example, referring to FIG. 12, the control unit 53 extracts the article numbers “A001”, “A002” and “A005” each associated with types of article on which a worker A has worked (or which are associated with a slip number “000123”). In addition, the number of the article information to be extracted may be one.

Next, the control unit 53 extracts the warehouse coordinates each associated with the article information having been extracted in S301 by using the article arrangement DB 51c (S302). As an example, the control unit 53 extracts shelf numbers “II-6”, “II-1” and “I-3” which correspond to the article numbers “A001”, “A002” and “A005”, respectively, by referring to FIG. 13B, and extracts the warehouse coordinates each associated with the extracted shelf numbers from a separately generated list in which the shelf numbers and the warehouse coordinates are stored.

Next, the control unit 53 determines whether flow line data includes place information which falls within a predetermined range from an arrangement place designated by the warehouse coordinates (S303). As an example, the control unit 53 determines whether place information included in flow line data falls within the predetermined range, for example, 100 centimeters from an arrangement place designated by the warehouse coordinates having been extracted from the article arrangement information. Further, in the case where the arrangement information is a grid number (or a cell number) on a warehouse, the control unit 53 may determine whether flow line data includes warehouse coordinates which falls within a predetermined range from extracted grid numbers. Further, in the case where both of the arrangement information and the place information related to flow line data are each a grid number (or a cell number), the control unit 53 may determine whether a grid number included in flow line data falls within a predetermined range from the extracted grid numbers. In addition, “within predetermined range from an extracted grid number” means “within a range covering, for example, segments adjacent to a segment designated by the extracted grid number or segments falling within a range which is appropriately determined from a segment designated by the extracted grid number”. In the case where the article arrangement information is the warehouse coordinates, and the place information related to flow line data is a grid number, the determination can be made in the same way as described above. In this case, the control unit 53 determines that the flow line data X includes place information which falls within one of ranges each having a width of several meters from the warehouse coordinates associated with the extracted shelf numbers “II-6”, “II-1” and “I-3”.

Further, the control unit 53 associates the specific key information (such as the worker information or the slip information) with flow line data related to a worker (S304). As an example, as described above, it is possible to associate the worker A (or the slip number “000123”) with the flow line data X by causing the article number and the article arrangement information which are included in an work log, and place information corresponding to flow line work action information extracted from flow line data to be associated with one another.

As described above, according to this exemplary embodiment, it is possible to, through the additional use of the article arrangement information, associate an flow line data with worker identification information merely by calculating, as flow line work action information, a distance between a position of a worker who has passed by a shelf on which the article is arranged and a position of the shelf. Further, in this association, it is unnecessary to use any image recognition technology of high accuracy sufficient to recognize actions, such as an action of stretching an arm towards a shelf, on an image basis.

Here, the control unit 53 can also associate flow line data with worker identification information by preliminarily extracting flow line work action information and place information (such as pairs of warehouse coordinates, shelf numbers, grid numbers or cell numbers) from the flow line data to generate a list consisting of the extracted information, and comparing the extracted information with the arrangement information having been extracted in S30 shown in FIG. 4. Specifically, the control unit 53 detects flow line work action information from flow line data stored in the flow line DB 51a; extracts place information (such as pairs of warehouse coordinates, shelf numbers, grid numbers or cell numbers) each of which is related to flow line data and is associated with the detected flow line work action information; and generates a list including the detected flow line work action information and the extracted place information. Further, the control unit 53 can associate the specific key information (such as the worker information or the slip information) with flow line data by determining whether any one of detected place information related to flow line data falls within a predetermined range from a position designated by the arrangement information having been extracted from the article arrangement information. Through these processes, an association of flow line data with worker identification information can be made merely by performing a mutual collation among table information, and thus, it is possible to achieve the reduction of processing wait time, the reduction of concentration of processing loads and the improvement of a processing speed.

### Modification Example

In the aforementioned exemplary embodiment 2, an association is made on the basis of time information, and in the aforementioned exemplary embodiment 3, an association is made on the basis of article number information and place information (such as coordinates or a shelf number) related to flow line data. Meanwhile, the association can be also made by using a total number of articles. For example, a control unit extracts a total number of articles on which a worker has performed works, from an work log, and a total number of flow line work action information from flow line data, and can collate these two kinds total numbers. Through this method, it becomes unnecessary to record time information, the article number information, shelf number information and the like in an work log, flow line data and the like, so that it becomes possible to associate one of flow line data with worker identification information on a simplified configuration basis.

Further, in each the aforementioned exemplary embodiments, it is also possible to generate a list in which priority levels each being associated with the article work information extracted from an work log and being determined on the basis of a feature amount of a corresponding type of article are stored for the article; store the list in a storage unit, and make associations in descending order from the article whose feature amount has the highest priority level. For example, as a reference level for the determination of the priority levels, a weight or a total number of the article can be used. Further, as a reference level for the determination of priority levels, a time zone related to flow line data can be used. In this way, since it becomes easy to extract flow line work action information because the length of a duration of a stopping action becomes longer as a weight of a target type of article become larger and/or a total number of picking actions becomes larger, it is possible to further improve the degree of accuracy of an association of flow line data with worker identification information.

Moreover, any appropriate combination of the features of the aforementioned individual exemplary embodiments may be made. Specifically, a control unit extracts article numbers of types of article and log clock time information from the work log, and further, extracts arrangement places (shelf numbers or pairs of warehouse coordinates) associated with the article numbers from the article arrangement information. Next, the control unit detects flow line work action information from flow line data, and further, extracts place information (a shelf number or warehouse coordinates) and time information which are associated with the extracted flow line work action information. Further, the control unit determines whether place information having been extracted from flow line data falls within a predetermined range from the arrangement places of types of article, having been extracted from the article arrangement information, and concurrently therewith, the control unit determines whether time information having been extracted from flow line data falls within a predetermined range from the log clock time information, having been extracted from the work log. Further, in the case where it is determined that the place information having been extracted from flow line data and one of the at least time information having been extracted from the flow line data fall within a predetermined range and, respectively, the control unit associates the specific key information (such as the worker information or the slip information) with flow line data corresponding to a worker. Through this processing, an association of flow line data with worker identification information can be made merely by performing a mutual collation among table information, and thus, it is possible to achieve the improvement of the degree of accuracy of an association, simultaneously with the reduction of a processing load and the improvement of a processing speed.

Further, as an appropriate combination of the features of the aforementioned individual exemplary embodiments, first, a control unit uses place information included in flow line data, and determines whether place information falls within a predetermined range determined from articles numbers included in an work log. Subsequently, the control unit uses time information included in flow line data, and determines whether any one of the time information falls within a predetermined range determined from clock time information included in the work log. After having narrowed the flow line data to some extent in this way, the control unit may detect flow line work action information from narrowed line data, and then, may concurrently make a first determination and a second determination: the first one being a determination as to whether place information (such as coordinates or a shelf number), which is associated with the flow line work action information, falls within a predetermined range from a articles numbers included in an work log; the second one being a determination as to whether place information (such as coordinates or a shelf number), which is associated with flow line work action information, falls within a predetermined range from clock time information included in the work log. As a result, since the flow line work action information is detected from narrowed flow line data, flow line data targeted for a heavily-loaded process of detecting flow line work action information can be reduced, and thus, it is possible to achieve the reduction of a processing load.

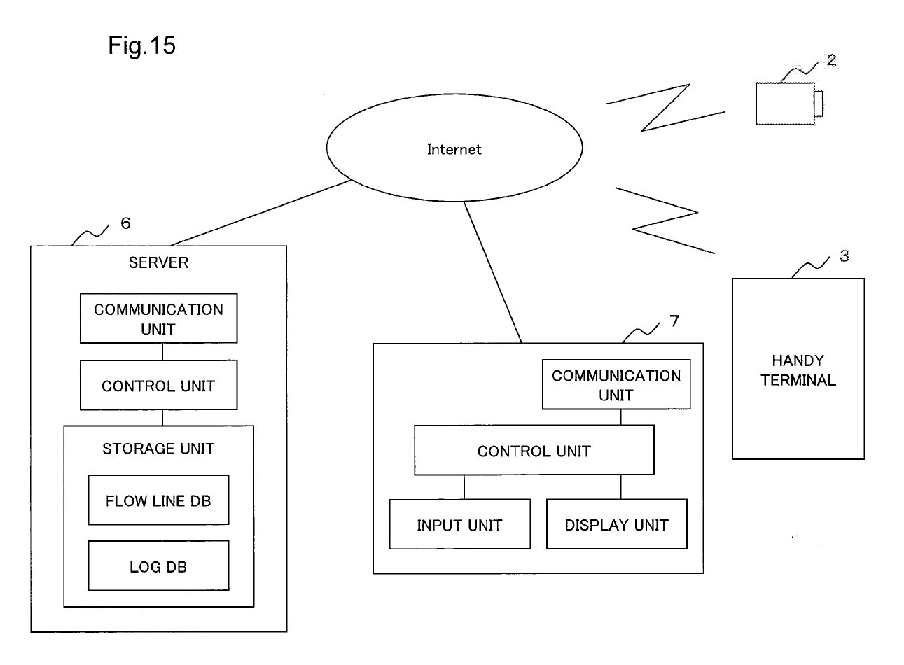

In each the aforementioned exemplary embodiment, as shown in FIG. 15, a configuration may be made such that the location detection device 2 and the handy terminal 3 transmit data to a flow line data analysis server 6 via the Internet, and the flow line data analysis server 6 includes the storage unit and the control unit of each of the aforementioned exemplary embodiments. In this way, a terminal 7 is connected to the flow line data analysis server 6, so that various kinds of data, such as work log and flow line data, as well as data resulting from associating an flow line data with worker identification data, can be displayed on a display portion of the terminal 7. For this reason, an administrator of worker can obtain advantageous effects of some aspects of the present invention, merely by being provided with the location detection device 2, the handy terminal 3 and the terminal 7.

Further, in each the aforementioned exemplary embodiments, it is possible to, through the use of, besides an work log information, information resulting from worker's operations of communication terminals (such as PCs) installed inside an warehouse or the like, associate the specific key information (such as the worker information or the slip information) with flow line data related to a worker. Specifically, a storage unit stores information related to location of communication terminal installed in a warehouse or the like. Further, the communication terminal has a function of notifying a control unit of the worker information related to the worker having operated the communication terminal itself, or a slip number having been inputted to the communication terminal itself by the worker.

Operations of this configuration will be described. The control unit extracts a specific worker having operated one of the communication terminals. Further, the control unit extracts an flow line data which passes by an area near a place where the communication terminal is installed. Further, the control unit associates the specific key information (such as the worker information or the slip information) with the flow line data related to a worker. In this way, it is possible to further improve the degree of accuracy of an association of the specific key information with the flow line data related to a worker.

Further, in each of the aforementioned exemplary embodiments, the description has been made by way of an example in which targets for an analysis are flow line data each associated with the worker who collect articles, but an object which collects articles may not human being but a riding machine, such as a forklift, an automated robot or a trained animal. Further, flow line data for use in such a case may not be ones for worker but ones for trained animals, automated robots, forklifts, cranes, trucks or the like.

Hereinbefore, the present invention has been described with reference to embodiments (practice examples), but are not limited to the aforementioned embodiments (practice examples). Various modifications that can be understood by those skilled in the art can be made on the configurations and details of the present invention within the scope of the present invention.

This application is based upon and claims the benefit of priority from Japanese patent application No. 2012-080278, filed on Mar. 30, 2012, the disclosure of which is incorporated herein in its entirety by reference.

### REFERENCE SIGNS LIST

1, 4 and 5: Flow line data analysis device
2: Location detection device
3: Handy terminal
6: Flow line data analysis server

1. A flow line analysis device comprising:
a log storage unit which stores work log including key information which encompasses at least one of worker information, slip information and work item, and work information associated with the key information;
a flow line storage unit which stores flow line data of the worker; and
a control unit,
wherein the control unit extracts work information associated with specific key information from the work log, and determines whether the flow line data which includes flow line work information which satisfies a predetermined condition defined by work information, and associates the key information with the flow line data when it is determined that the flow line data includes the flow line work information.

2. The flow line analysis device according to claim 1,
wherein the work information is article information which includes an article number or an article name related to a past work of the worker,
wherein the storage unit stores article arrangement information representing an arrangement place of the article information,
wherein the flow line work information is place information which is included in the flow line data and which represents a place related to a past movement of the worker, and
wherein the control unit extracts the article work information which is associated with a specific key information, extracts an arrangement place related the article being determined in accordance with the article work information by using the article arrangement information, and determines whether flow line data includes the place information which falls within a predetermined range from the arrangement place.

3. The flow line analysis device according to claim 1,
wherein the work information is log clock time information representing a clock time of a past work of the worker; and the flow line work information is time information which represents a place related to a past movement of the worker into the flow line data, and
wherein the control unit extracts the log clock time information which is associated with a specific key information; and determines whether flow line data includes the time information which falls within a predetermined range from the log clock time information.

4. The flow line analysis device according to claim 1,
wherein the control unit detects flow line work action information representing a past work of the worker from the flow line data, and extracts flow line work information included in the flow line work action information, and determines whether flow line work information included in flow line data satisfies predetermined condition determined in accordance with the article work information.

5. The flow line analysis device according to claim 1,
wherein the storage unit further stores determination priority level information associated with the article acquisition information; and
wherein the control unit makes determination in descending order from the article work information which has the highest priority level on the basis of the determination priority level information.

6. A flow line data analysis system comprising:
the flow line data analysis device according to claim 1;
a location detection device which generates photograph data; and
a communication terminal which generates information constituting the work log by using a wireless tag reader, and transmits the generated information to the flow line data analysis device.

7. A flow line data analysis method comprising:
storing a work log including key information which encompasses at least one of worker information, slip information and a work item, and work information associated with key information;
storing flow line data associated with a worker;
extracting work information associated with specific key information from the work log;
determining whether the flow line data which includes flow line work information which satisfies a predetermined condition determined in accordance with the work information; and
associating the specific key information with the flow line data when it is determined that the flow line data includes the flow line work information.

8. The flow line analysis method according to claim 7,
wherein the work information is article information which includes an article number or an article name of the article related to a past work of the worker,
further comprising:
storing the article information and article arrangement information representing an arrangement place of the article;
wherein flow line work information is included in the flow line data, and include place information each representing a place related to a past movement of the worker the worker,
storing the article work information which is associated with a specific key information;
extracting an arrangement place related the article determined in accordance with the article work information by using the article arrangement information; and
determining whether the flow line data includes the place information which falls within a predetermined range from the an arrangement place.

9. The flow line analysis method according to claim 7,
wherein the work information is log clock time information representing a clock time of a past work of the worker; and the flow line work information is time information which is included in flow line data and which represents a place related to a past movement of the worker, and
further comprising:
extracting the log clock time information which is associated with the specific key information; and
determining whether the flow line data includes the time information which falls within a predetermined range from the log clock time information.

10. A non-transitory computer readable medium which stores a flow line analysis program which makes a computer operate as functions for analyzing flow line data, comprising:
a log storage unit which stores work log including key information which encompasses at least one of worker information, slip information and work item, and work information associated with the key information;
a flow line storage unit which stores flow line data of the worker; and
a control unit which extracts work information associated with specific key information from the work log, and determines whether the flow line data which includes flow line work information which satisfies a predetermined condition defined by work information, and associates the key information with the flow line data when it is determined that the flow line data includes the flow line work information.

11. A flow line analysis device comprising:
a log storage means for storing work log including key information which encompasses at least one of worker information, slip information and work item, and work information associated with the key information;
a flow line storage means for storing flow line data of the worker; and
a control means for extracting work information associated with specific key information from the work log, and determining whether the flow line data which includes flow line work information which satisfies a predetermined condition defined by work information, and associating the key information with the flow line data when it is determined that the flow line data includes the flow line work information.
